(19) United States
(12) Patent Application Publication
(10) Pub. No.: US 2015/0241032 A1
(43) Pub. Date: Aug. 27, 2015

(54) ILLUMINATION DEVICE

(71) Applicant: Panasonic Intellectual Property Management Co., Ltd., Osaka (JP)

(72) Inventor: Hideharu KAWACHI, Hyogo (JP)

(21) Appl. No.: 14/602,761

(22) Filed: Jan. 22, 2015

(30) Foreign Application Priority Data
Feb. 25, 2014 (JP) 2014-034690

(51) Int. Cl. F21V 15/01; F21V 7/00

(52) U.S. Cl. CPC F21V 15/01; F21V 7/00

(57) ABSTRACT

An illumination device includes a plate-shaped light-transmitting member having a light-transmitting region, a fixture having a box shape with one open surface, the fixture attached to the light-transmitting member such that the open surface faces the light-transmitting member, and a light emitting module inserted into the fixture. The fixture includes an insertion opening formed on a surface perpendicular to the open surface, the light emitting module slidingly inserted into the insertion opening along the light-transmitting member. The light emitting module includes a planar light emitter having a light emission surface and a holder configured to hold the planar light emitter and configured to engage with the fixture such that the light emission surface overlaps with the light-transmitting region. The holder protrudes in an insertion direction of the light emitting module beyond a contour of the planar light emitter.

### CROSS-REFERENCE TO RELATED APPLICATION

This application claims priority to Japanese Patent Application No. 2014-034690 filed on Feb. 25, 2014, the entire contents of which are incorporated herein by reference.

### TECHNICAL FIELD

The present disclosure relates to an illumination device provided with a light emitter which emits light in a planar pattern.

### BACKGROUND ART

Conventionally, there are known a planar light emitter which makes use of a light emitting module provided with an organic EL (Electro-Luminescence) element, and an illumination device provided with the planar light emitter (see, e.g., Japanese Unexamined Patent Application Publication No. 2013-182867). The planar light emitter disclosed in Japanese Unexamined Patent Application Publication No. 2013-182867 includes transparent substrates, an organic EL light emitting layer interposed between a pair of electrodes, and a sealing plate that seals the electrodes and the organic EL light emitting layer between the transparent substrates.

In the conventional planar light emitter, for example, glass substrates are used as the transparent substrates. For that reason, the planar light emitter is vulnerable to impact and may possibly be broken when it collides with another member.

### SUMMARY OF THE INVENTION

In view of the above, the present disclosure provides an illumination device provided with an adequately-protected light emitter.

In accordance with an aspect of the present invention, there is provided an illumination device, including: a plate-shaped light-transmitting member having a light-transmitting region; a fixture having a box shape with one open surface, the fixture being attached to the light-transmitting member such that the open surface faces the light-transmitting member; and a light emitting module inserted into the fixture, wherein the fixture includes an insertion opening formed on a surface perpendicular to the open surface, the light emitting module slidingly being inserted into the insertion opening along the light-transmitting member, wherein the light emitting module further includes a planar light emitter having a light emission surface and a holder configured to hold the planar light emitter and configured to engage with the fixture such that the light emission surface overlaps with the light-transmitting region, and wherein the holder protrudes in an insertion direction of the light emitting module beyond a contour of the planar light emitter.

The holder may be provided on the opposite surface of the planar light emitter from the light emission surface and is larger in area than the contour of the planar light emitter.

The fixture may include a flat plate portion which forms the opposite surface of the fixture from the open surface and an elastically-deformable salient portion protruding from the flat plate portion toward the open surface.

The holder may include a hole configured to engage with the salient portion.

The flat plate portion may include a cutout formed in a portion of a periphery of the salient portion, the salient portion having a shape obtained by bending a portion of the flat plate portion.

The salient portion may include a slant surface slanted with respect to the insertion direction of the light emitting module.

The salient portion may further include a vertical surface perpendicular to the insertion direction of the light emitting module.

The fixture may include a plate-shaped contact portion configured to form a surface opposite to the insertion opening and configured to make contact with an end surface of the light emitting module, the insertion opening being larger in width than the contact portion.

The fixture may include a plate-shaped contact portion configured to form a surface opposite to the insertion opening and configured to make contact with an end surface of the light emitting module, the contact portion including a first opening.

The flat plate portion may include a second opening joined to the first opening.

The light-transmitting member may further include a mirror region provided around the light-transmitting region and configured to reflect external light.

The planar light emitter may include a reflection electrode which reflects light, the light-transmitting region configured to transmit external light when the light emitting module is turned off and to transmit the external light reflected by the reflection electrode.

The flat plate portion may have a major surface facing the light-transmitting member, the major surface being a mirror surface.

The fixture may be attached to the light-transmitting member at a position closer to an edge of the light-transmitting member than a center of the light-transmitting member and the insertion opening is provided at a position closer to the center of the light-transmitting member than the edge of the light-transmitting member.

With such a configuration, it is possible to provide an illumination device provided with an adequately-protected light emitter.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is a schematic perspective view showing one example of an illumination device according to an embodiment of the present invention.

FIGS. 2A and 2B are views showing use examples of the illumination device according to the embodiment of the present invention.

FIG. 3 is an exploded perspective view showing one example of the illumination device according to the embodiment of the present invention.

FIG. 4 is a schematic perspective view showing one example of a fixture according to the embodiment of the present invention.

FIG. 5A is a plan view showing one example of the arrangement of fixtures and light emitting modules on a light-transmitting member according to the embodiment of the present invention.

FIG. 5B is a plan view showing another example of the arrangement of fixtures and light emitting modules on a light-transmitting member according to the embodiment of the present invention.

FIGS. 6A and 6B are views showing one example of sliding insertion of the light emitting module according to the embodiment of the present invention.

FIGS. 7A and 7B are respectively a sectional view and a plan view showing one example of the light emitting module according to the embodiment of the present invention.

FIG. 8 is a sectional view showing one example of a protrusion portion of a holder according to the embodiment of the present invention.

FIG. 9A is a sectional view showing one example of a salient portion of a fixture according to the embodiment of the present invention.

FIG. 9B is a sectional view showing another example of a salient portion of a fixture according to the embodiment of the present invention.

FIG. 10 is a plan view showing a fixture according to a modified example of the embodiment of the present invention.

FIG. 11 is a perspective view showing a fixture according to another modified example of the embodiment of the present invention.

FIG. 12 is a plan view showing a light emitting module according to a further modified example of the embodiment of the present invention.

### DETAILED DESCRIPTION

(Findings which Form the Basis of the Present Invention)

The present inventor has found that the illumination device mentioned in the section “Background Art” suffers from the following problems.

A light emitting module for use in an illumination device is degraded during the continuous use of the illumination device. For example, a light emitting element such as an organic EL element or the like provided in a light emitting module shows a decrease in light emission amount due to the degradation thereof. For that reason, in the illumination device, it is required that the light emitting module be replaceable. However, during the replacement of the light emitting module, there is a possibility that the light emitting module collides with a fixture or the like and gets broken.

For example, in order to smoothly perform the replacement of the light emitting module, it is thinkable to slidingly insert or remove the light emitting module into and from a specified fixture. In this case, when the light emitting module is slid, the end portion of the light emitting module inadvertently collides with the fixture. Thus, there is a possibility that a member vulnerable to impact, such as a glass substrate or the like, is broken.

Under the circumstances, it is required that a light emitter be protected when the light emitting module is slidingly inserted.

In order to solve the aforementioned problems, the illumination device according to one embodiment of the present invention includes: a plate-shaped light-transmitting member having a light-transmitting region; a fixture having a box shape with one open surface, the fixture attached to the light-transmitting member such that the open surface faces the light-transmitting member; and a light emitting module inserted into the fixture, wherein the fixture includes an insertion opening formed on a surface perpendicular to the open surface, the light emitting module slidingly inserted into the insertion opening along the light-transmitting member, the light emitting module includes a planar light emitter having a light emission surface and a holder configured to hold the planar light emitter and configured to engage with the fixture such that the light emission surface overlaps with the light-transmitting region, and the holder protrudes in an insertion direction of the light emitting module beyond a contour of the planar light emitter.

This makes it possible to provide an illumination device provided with an adequately-protected light emitter.

A illumination device according to an embodiment of the present invention will now be described in detail with reference to the accompanying drawings. The embodiment described herein after shows one specific preferred example of the present invention. Accordingly, the numerical values, the shapes, the materials, the constituent elements, the arrangement of constituent elements, the connection forms, etc., described below in connection with the embodiment are nothing more than one example and are not intended to limit the present invention. Among the constituent elements of the embodiment described below, the constituent elements not recited in the independent claim which defines the top-level concept of the present invention will be described as arbitrary constituent elements.

The respective figures of the drawings are schematic diagrams and are not strictly descriptive figures. In the respective figures, identical constituent elements will be designated by like reference symbols.

### Embodiment

### Overview of Illumination Device

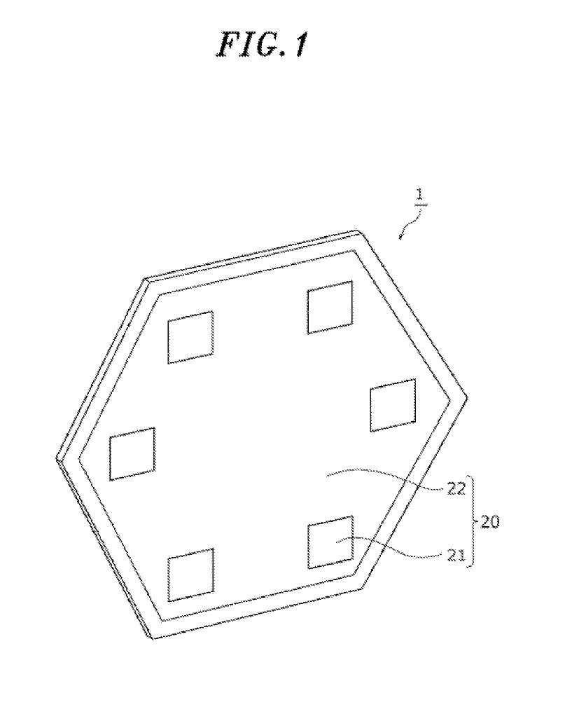

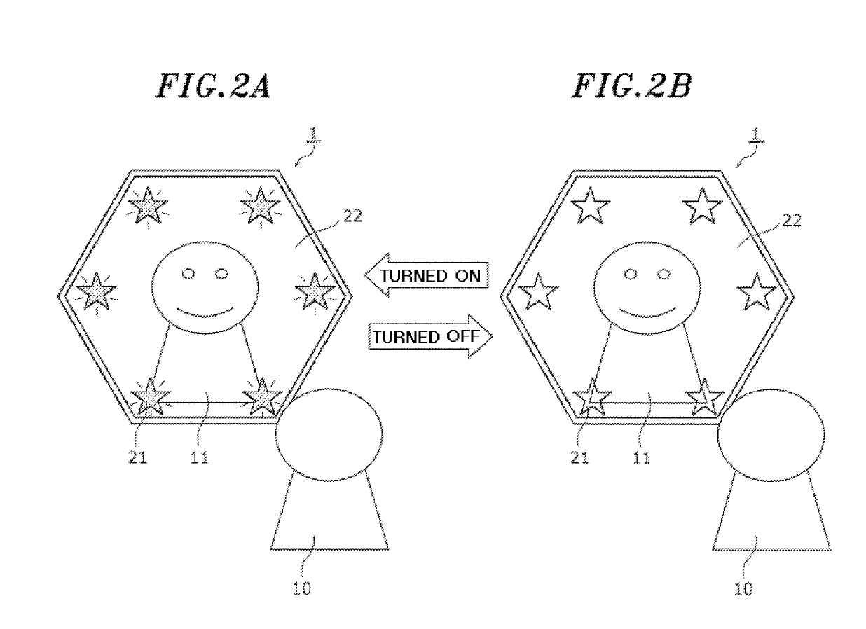

First, the overview of an illumination device according to the present embodiment will be described with reference to FIGS. 1, 2A and 2B. FIG. 1 is a schematic perspective view showing an illumination device 1 according to the present embodiment. FIGS. 2A and 2B are views showing use examples of the illumination device 1 according to the present embodiment.

The illumination device 1 is a mirror with an illumination function. As shown in FIG. 1, the illumination device 1 includes a light-transmitting member 20 having light-transmitting regions 21 and a mirror region 22. The light-transmitting regions 21 are disposed at the positions closer to the edge of the light-transmitting member 20 than the center thereof.

When the illumination device 1 is turned on, as shown in FIG. 2A, light is emitted from the light-transmitting regions 21 and a mirror image 11 of a subject 10 is reflected by the mirror region 22. In other words, in the illumination device 1, the central portion of the light-transmitting member 20 serves as a mirror that reflects the mirror image 11 of the subject 10. The peripheral edge portion of the light-transmitting member 20 irradiates light on the subject 10.

On the other hand, when the illumination device 1 is turned off, as shown in FIG. 2B, the entire surface thereof serves as a mirror. That is to say, the light-transmitting regions 21 and the mirror region 22 can reflect the mirror image 11.

In the example shown in FIG. 1, the light-transmitting regions 21 have a rectangular shape. However, the shape of the light-transmitting regions 21 is not limited thereto. The light-transmitting regions 21 may be formed of a predetermined diagram such as a star or the like as shown in FIGS. 2A and 2B or may be a combination of different diagrams. Alternatively, the light-transmitting regions 21 may have the shape of a character of an animation or the like.

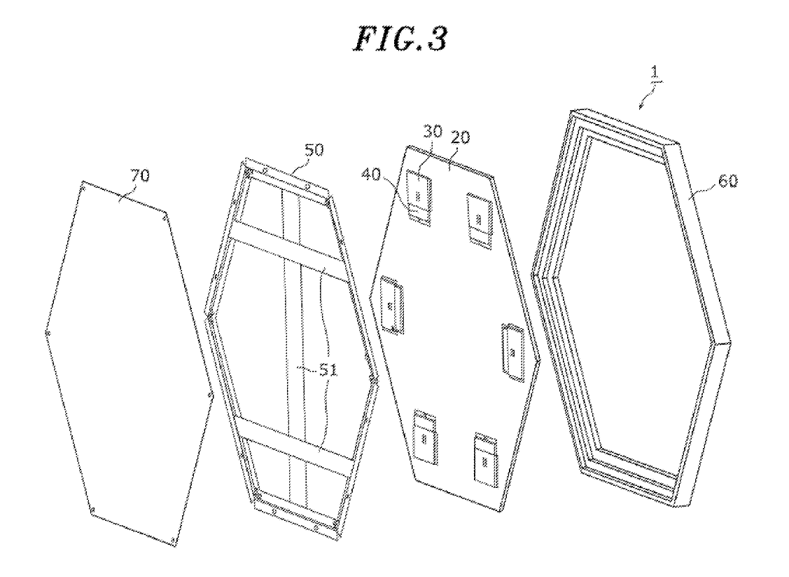

Subsequently, the detailed configuration of the illumination device 1 according to the present embodiment will be described with reference to FIG. 3. FIG. 3 is an exploded perspective view showing the illumination device 1 according to the present embodiment. In FIG. 3, there is shown the illumination device 1 which is seen from the rear surface side thereof. The side at which light is emitted will be referred to as a front surface side. The side opposite to the front surface side will be referred to as a rear surface side.

As shown in FIG. 3, the illumination device 1 includes a light-transmitting member 20, fixtures 30, light emitting modules 40, a frame 50, a wooden frame 60 and a rear surface cover 70.

(Light-Transmitting Member)

First, the light-transmitting member 20 will be described with reference to FIGS. 1 and 3.

As shown in FIG. 1, the light-transmitting member 20 is a plate-shaped light-transmitting member having light-transmitting regions 21 and a mirror region 22.

As shown in FIG. 3, the light-transmitting member 20 has, e.g., a hexagonal shape when seen in a plan view. However, the shape of the light-transmitting member 20 is not limited thereto. The plan-view shape of the light-transmitting member 20 may be a polygonal shape such as a triangular shape or a square shape, a circular shape or an elliptical shape.

By the term “plan-view”, it is meant that the light-transmitting member 20 is seen from the front surface side or the rear surface side. Accordingly, the plan-view shape of the light-transmitting member 20 is the shape of the light-transmitting member 20 which is seen from the front surface side or the rear surface side thereof.

The light-transmitting member 20 is formed of a light-transmitting plate-shaped member such as, e.g., a glass plate or an acrylic plate. A metal such as aluminum or silver is vapor-deposited on one major surface (the rear surface) of the light-transmitting member 20 except some regions.

The light-transmitting regions 21 refer to the regions where a metal is not vapor-deposited and transmit the light emitted from the light emitting modules 40. For example, the size of each of the light-transmitting regions 21 is substantially equal to or smaller than the size of the light emission surface of each of the light emitting modules 40.

The light-transmitting regions 21 are formed by etching some portions of the metal vapor-deposited on the entire surface of the light-transmitting member 20. Alternatively, the light-transmitting regions 21 may be formed by vapor-depositing a metal using masks which cover the light-transmitting regions 21.

The light-transmitting regions 21 are the regions that transmit the light emitted from the light emitting modules 40 when the illumination device 1 is turned on and consequently look shiny to the subject 10. The light-transmitting regions 21 are provided at the positions closer to the edge of the light-transmitting member 20 than the center thereof. Thus, even when the illumination device 1 is turned on, the central portion of the light-transmitting member 20 can be used as a mirror.

The mirror region 22 is a region that reflects external light. For example, the mirror region 22 is a region where a metal is vapor-deposited. The vapor-deposited metal reflects the light coming from the subject 10, thereby enabling the mirror region 22 to reflect the mirror image 11 of the subject 10. The mirror region 22 is provided around the light-transmitting regions 21. More specifically, the mirror region 22 is a plane region of the light-transmitting member 20 other than the light-transmitting regions 21.

The light-transmitting member 20 may be a plate member having a light shielding property, such as a metal plate or the like. In this case, one or more through-holes may be formed in the light-transmitting member 20 such that the through-holes serve as the light-transmitting regions 21.

(Fixture)

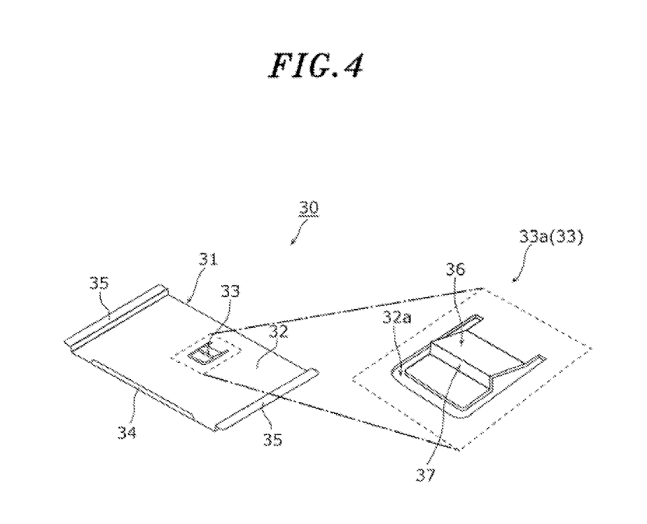

Next, the fixture 30 will be described with reference to FIGS. 3 and 4. FIG. 4 is a schematic perspective view showing the fixture 30 according to the present embodiment.

As shown in FIG. 4, the fixture 30 is a box-shaped fixture with one open surface (a first surface). In the example shown in FIG. 4, the first surface is a ceiling surface positioned at the upper side of the drawing sheet. The ceiling surface is opened.

As shown in FIG. 3, the fixture 30 is attached to the light-transmitting member 20 such that the open surface (the first surface) thereof faces the light-transmitting member 20.

For example, the fixture 30 is bonded, by an adhesive agent, to the rear surface of the light-transmitting member 20 so as to cover at least a portion of each of the light-transmitting regions 21. The adhesive agent may be, e.g., a double-side tape.

The plan-view shape of the fixture 30 is substantially identical with the shape of a portion of the contour of the light emitting module 40. In the present embodiment, the contour of the light emitting module 40 is substantially rectangular. Thus, the plan-view shape of the fixture 30 is also rectangular. The fixture 30 and the light-transmitting member 20 cooperate with each other to define a substantially rectangular parallelepiped space into which the light emitting module 40 is inserted.

The fixture 30 is made of, e.g., a metallic material such as aluminum or stainless steel, or a resin material. In order for the fixture 30 to press the light emitting module 40 against the light-transmitting member 20, the fixture 30 is preferably made of a rigid material such as stainless steel or the like. For example, the fixture 30 is formed by pressing a metal plate.

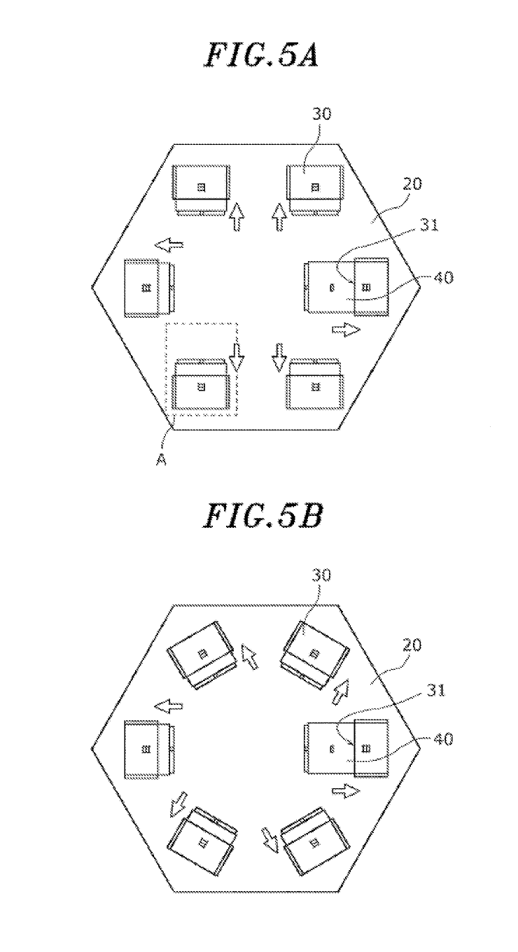

The arrangement of the fixtures 30 with respect to the light-transmitting member 20 according to the present embodiment will now be described with reference to FIGS. 5A and 5B. FIGS. 5A and 5B are plan views showing one example of the arrangement of the fixtures 30 and the light emitting modules 40 with respect to the light-transmitting member 20 according to the present embodiment.

As shown in FIGS. 5A and 5B, the fixtures 30 are attached to the light-transmitting member 20 at the positions closer to the edge of the light-transmitting member 20 than the center thereof. For example, the fixtures 30 are disposed at the positions closer to the end surface of the light-transmitting member 20 than the center thereof. In other words, each of the fixtures 30 is disposed in the position closer to the end surface of the light-transmitting member 20 than the midpoint of a line segment which interconnects the center and the end surface of the light-transmitting member 20. The positions of the fixtures 30 correspond to the positions of the light-transmitting regions 21 (and the light emitting modules 40).

In the present embodiment, a plurality of fixtures 30 is attached to the light-transmitting member 20. In the example shown in FIGS. 5A and 5B, six fixtures 30 are disposed in the positions closer to the edge of the light-transmitting member 20.

The arrows shown in FIGS. 5A and 5B indicate the insertion directions of the light emitting modules 40. As shown in FIGS. 5A and 5B, the insertion directions of the light emitting modules 40 are oriented from the center of the light-transmitting member 20 toward the edge thereof. In other words, the insertion openings 31 into which the light emitting modules 40 are inserted are formed in the positions closer to the center of the light-transmitting member 20 than the edge thereof.

The fixtures 30 shown in FIG. 5A and the fixtures 30 shown in FIG. 5B are identical in the arrangement position with each other but are different in the arrangement orientation from each other. In the example shown in FIG. 5A, six fixtures 30 are arranged in such orientations that the fixtures 30 are in line symmetry with one another. The axis of line symmetry passes through the center of the light-transmitting member 20 and extends parallel to the up-down direction or the left-right direction of the drawing sheet.

In the example shown in FIG. 5B, six fixtures 30 are arranged in such orientations that the fixtures 30 are in point symmetry (rotation symmetry) with one another. The center of point symmetry (rotation symmetry) is the center of the light-transmitting member 20. In the example shown in FIG. 5B, the respective insertion openings 31 of the fixtures 30 face toward the center of the light-transmitting member 20. In other words, the insertion directions of the light emitting modules 40 extend radially outward from the center of the light-transmitting member 20.

The arrangement and orientation of the fixtures 30 shown in FIGS. 5A and 5B are nothing more than one example. The present invention is not limited thereto. While the fixtures 30 are spaced apart from each other, they may adjoin each other.

Next, the detailed configuration of the fixture 30 according to the present embodiment will be described with reference to FIG. 4. As shown in FIG. 4, the fixture 30 is a substantially rectangular solid having two open surfaces orthogonal to each other. A first surface (ceiling surface) as one of the two open surfaces faces toward the light-transmitting member 20. When the fixture 30 is attached to the light-transmitting member 20, the first surface is covered by the light-transmitting member 20. A second surface as the other of the two open surfaces corresponds to the insertion opening 31.

As shown in FIG. 4, the fixture 30 includes a flat plate portion 32, a salient portion 33, a contact portion 34 and bonding portions 35. The flat plate portion 32, the contact portion 34 and the bonding portions 35 define the remaining four surfaces of the substantially rectangular solid with two open surfaces.

The insertion opening 31 is an opening formed in the surface perpendicular to one open surface (the first surface). The light emitting module 40 is slidingly inserted into the insertion opening 31 along the light-transmitting member 20. More specifically, the insertion opening 31 corresponds to the second surface as one open surface of the six surfaces of the substantially rectangular solid. The size of the insertion opening 31 is larger than the size of the end surface of the light emitting module 40 and may be, for example, substantially equal to the size of the end surface of the light emitting module 40.

In the present embodiment, the second surface opened as above corresponds to the insertion opening 31. However, the present invention is not limited thereto. For example, the insertion opening 31 may be an opening formed in a portion of a plate which constitutes the second surface.

The flat plate portion 32 is a flat plate portion having a plate shape, which constitutes a surface opposite to one open surface (the first surface). More specifically, the flat plate portion 32 constitutes a surface facing the light-transmitting member 20. When the light emitting module 40 is slidingly inserted into the insertion opening 31, the flat plate portion 32 makes contact with the light emitting module 40. The flat plate portion 32 is parallel to the light-transmitting member 20.

The major surface of the flat plate portion 32 facing toward the light-transmitting member 20, namely the inner major surface of the flat plate portion 32, is a mirror surface. For example, the flat plate portion 32 is made of a glossy metallic material such as stainless steel or the like and, therefore, can reflect light. At this time, the reflectivity of the flat plate portion 32 may be increased by polishing the inner major surface of the flat plate portion 32.

In case where the light emitting module 40 is not inserted into the insertion opening 31, the light transmitting through the light-transmitting region 21 of the light-transmitting member 20 is reflected by the major surface of the flat plate portion 32 and is then transmitted through the light-transmitting region 21. Thus, the flat plate portion 32 can reflect the light coming from, e.g., the subject 10. This makes it possible to use the light-transmitting region 21 as a mirror even when the light emitting module 40 is not inserted into the insertion opening 31.

The flat plate portion 32 includes a cutout 32a formed partially around the salient portion 33. Due to the existence of the cutout 32a, the salient portion 33 is partially separated from the flat plate portion 32 and can be deformed with ease.

The salient portion 33 protrudes from the flat plate portion 32 toward one open surface (the first surface) and can be elastically deformed. In other words, the salient portion 33 protrudes in such a direction as to press the light emitting module 40 against the light-transmitting member 20.

The salient portion 33 can be elastically deformed in the normal direction of the flat plate portion 32. More specifically, during the time when the light emitting module 40 is inserted into the fixture 30, the salient portion 33 is pressed by the light emitting module 40 away from the light-transmitting member 20. The salient portion 33 thus elastically deformed presses the light emitting module 40 toward the light-transmitting member 20 by virtue of the reaction force thereof. This makes it possible to bring the light emitting module 40 into close contact with the light-transmitting member 20.

Alternatively, a plurality of salient portions 33 may be provided in the flat plate portion 32. The detailed shape of the salient portion 33 will be described later.

The contact portion 34 is a plate-shaped contact portion which constitutes a surface opposite to the insertion opening 31. The end surface of the light emitting module 40 makes contact with the contact portion 34. The contact portion 34 is a plate extending along the end surface orthogonal to the sliding direction (the insertion direction and the removal direction) of the light emitting module 40. More specifically, the contact portion 34 constitutes one of the remaining four surfaces of the substantially rectangular solid with two open surfaces, namely the surface opposite to the insertion opening 31. For example, the contact portion 34 is a plate which is perpendicular to the flat plate portion 32 and the light-transmitting member 20. The contact portion 34 is orthogonal to the sliding direction of the light emitting module 40.

The sliding-direction end surface of the light emitting module 40 makes contact with the contact portion 34. Since the end surface of the light emitting module 40 makes contact with the contact portion 34, it is possible to perform the positioning of the light emitting module 40.

The bonding portions 35 are bonded to the light-transmitting member 20 when attaching the fixture 30 to the light-transmitting member 20. For example, the bonding portions 35 are bonded to the light-transmitting member 20 by an adhesive agent such as a double-side tape or the like.

More specifically, the bonding portions 35 constitute two opposite surfaces of the remaining four surfaces of the substantially rectangular solid with two open surfaces, which are parallel to the sliding direction of the light emitting module 40. For example, the bonding portions 35 are plates perpendicular to the flat plate portion 32 and the light-transmitting member 20. The bonding portions 35 are extended in a direction parallel to the sliding direction of the light emitting module 40. The bonding portions 35 are provided with flanges in order to increase the bonding area between the bonding portions 35 and the light-transmitting member 20.

The bonding portions 35 serve as guide rails when the light emitting module 40 is inserted into the insertion opening 31. Furthermore, the bonding portions 35 perform the positioning of the light emitting module 40 in a left-right direction. The left-right direction refers to the direction perpendicular to the sliding direction of the light emitting module 40.

The contact portion 34 and the bonding portions 35 are provided to extend upright from the edges of the flat plate portion 32. The height of the contact portion 34 and the bonding portions 35 is substantially equal to the thickness of the light emitting module 40.

The flat plate portion 32, the salient portion 33, the contact portion 34 and the bonding portions 35 are one-piece formed by the same member (e.g., a metal plate). However, the present invention is not limited thereto. Alternatively, the flat plate portion 32, the salient portion 33, the contact portion 34 and the bonding portions 35 may be formed independently of one another.

The contact portion 34 and the bonding portions 35 may not be flat plates. For example, if the light emitting module 40 has a circular shape, the contact portion 34 and the bonding portions 35 may be curved plates which extend along an arc, i.e., the circumference of the light emitting module 40. Just like the bonding portions 35, the contact portion 34 may be bonded to the light-transmitting member 20.

(Light Emitting Module)

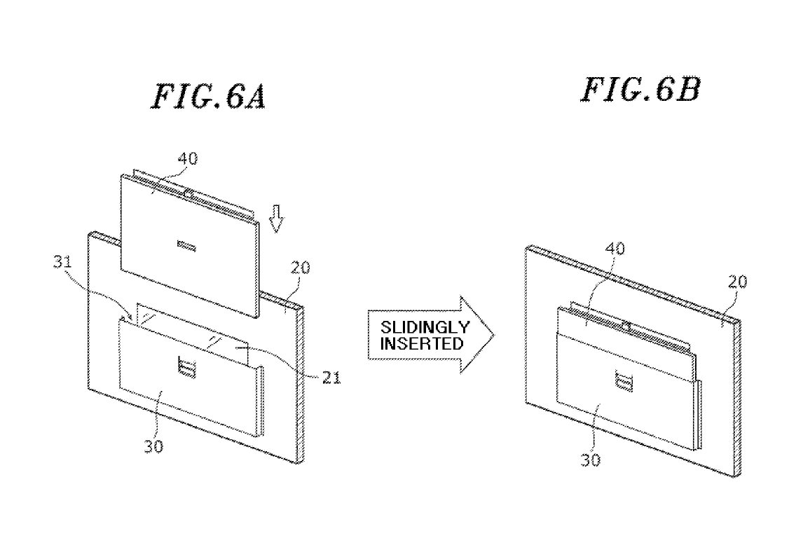

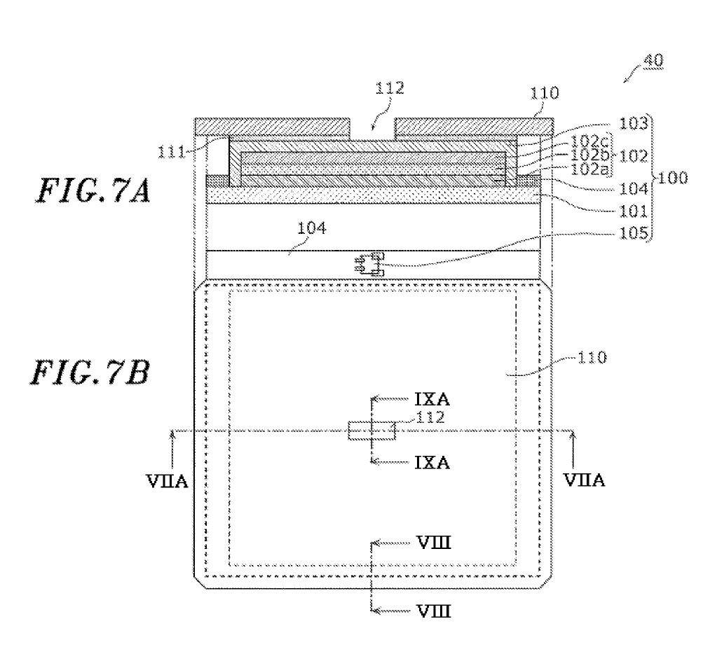

Next, the light emitting module 40 will be described with reference to FIGS. 6A to 7B. FIGS. 6A and 6B are views showing one example of sliding insertion of the light emitting module 40 according to the present embodiment. FIGS. 7A and 7B are respectively a sectional view and a plan view showing the light emitting module 40 according to the present embodiment.

The region A indicated in FIG. 5A is shown in FIGS. 6A and 6B.

As shown in FIGS. 7A and 7B, the light emitting module 40 includes a planar light emitter 100 and a holder 110. FIG. 7A shows a cross section taken along line VIIA-VIIA in FIG. 7B. More specifically, FIG. 7A shows a cross section passing through a hole 112 formed in the holder 110.

First, an insertion example of the light emitting module 40 will be described with reference to FIGS. 6A and 6B.

As shown in FIGS. 6A and 6B, the light emitting module 40 is inserted into the fixture 30. More specifically, the light emitting module 40 is slidingly inserted into the fixture 30 through the insertion opening 31 along the light-transmitting member 20. The insertion direction is, e.g., a direction parallel to the light-transmitting member 20 and orthogonal to the insertion opening 31.

As shown in FIG. 6B, the fixture 30 covers a portion of the light emitting module 40 inserted into the fixture 30. In other words, the light emitting module 40 is not completely accommodated within the fixture 30 but partially protrudes from the fixture 30. Thus, the light emitting module 40 can be easily removed by pressing and sliding the portion of the light emitting module 40 not covered with the fixture 30 (the portion of the light emitting module 40 protruding from the fixture 30).

As shown in FIG. 6A, the fixture 30 is provided so as to cover the light-transmitting region 21. This is to make sure that the light emission surface of the inserted light emitting module 40 overlaps with the light-transmitting region 21. More specifically, the fixture 30 covers a portion of the light-transmitting region 21. For example, if the inserted light emitting module 40 protrudes from the fixture 30, the light-transmitting region 21 also protrudes from the fixture 30.

The light emitting module 40 may be accommodated within the fixture 30. In other words, the entirety of the light emitting module 40 may be covered with the fixture 30.

(Planar Light Emitter)

Next, the planar light emitter 100 will be described. The planar light emitter 100 is a light emitter provided with a light emission surface and configured to emit light in a planar pattern.

The planar light emitter 100 includes a transparent substrate 101, an organic EL element 102, a encapsulating member 103, a FPC (Flexible Printed Circuit) 104 and a connector 105. The organic EL element 102 includes a first electrode 102a, an organic layer 102b including a light emitting layer, and a second electrode 102c.

The transparent substrate 101 is a transparent substrate that transmits at least a portion of visible light. The opposite major surface of the transparent substrate 101 from the surface on which the organic EL element 102 is provided is a light emission surface.

For example, the transparent substrate 101 is a glass substrate made of glass such as soda glass, non-fluorescent glass, phosphate-based glass, borate-based glass or the like. Alternatively, the transparent substrate 101 may be a quartz substrate or a plastic substrate.

The organic EL element 102 is provided on the transparent substrate 101 and is configured to emit light as a predetermined voltage is applied to between the first electrode 102a and the second electrode 102c.

The first electrode 102a is an electrode provided at the side of the light emission surface. For example, the first electrode 102a is provided on the transparent substrate 101. The first electrode 102a is, e.g., a positive electrode of the organic EL element 102. When light is emitted, a voltage higher than the voltage applied to the second electrode 102c is applied to the first electrode 102a.

The first electrode 102a is made of an transparent conductive material which transmits at least a portion of the visible light. For example, the first electrode 102a is made of indium tin oxide (ITO). For example, the first electrode 102a is formed by forming a conductive film with a vapor deposition method or a sputtering method and patterning the conductive film thus formed.

The organic layer 102b, which includes a light emitting layer, is provided between the first electrode 102a and the second electrode 102c. For example, the organic layer 102b includes a hole injection layer, a hole transport layer, a light emitting layer, an electron transport layer and an electron injection layer.

The light emitting layer is an organic layer that emits light in case where a predetermined voltage is applied to between the first electrode 102a and the second electrode 102c. For example, the light emitting layer emits light belonging to a visible light region (e.g., red light, blue light or white light).

The organic layer 102b is made of an organic material such as diamine, anthracene, metal complex or the like. For example, the organic layer 102b is formed by a vapor deposition method, a spin coat method, a cast method, etc.

The second electrode 102c is an electrode provided at the opposite side from the light emission surface. The second electrode 102c is provided on the organic layer 102b. The second electrode 102c is, e.g., a negative electrode of the organic EL element 102. When light is emitted, a voltage lower than the voltage applied to the first electrode 102a is applied to the second electrode 102c.

The second electrode 102c is made of, e.g., aluminum, silver, magnesium or an alloy containing at least one of these metals. For example, the second electrode 102c is formed by a vapor deposition method, a sputtering method, etc.

The second electrode 102c is a reflection electrode that reflects light. When the light emitting module 40 is turned on, the second electrode 102c reflects the light emitted from the organic layer 102b toward the light emission surface. When the light emitting module 40 is turned off, the second electrode 102c reflects the external light transmitted through the light-transmitting region 21, the transparent substrate 101, the first electrode 102a and the organic layer 102b. In other words, the light-transmitting region 21 transmits the external light when the light emitting module 40 is turned off, and also transmits the external light reflected by the second electrode 102c.

The encapsulating member 103 is provided so as to cover the organic EL element 102. The encapsulating member 103 protects the organic EL element 102 from the ambient air. More specifically, the encapsulating member 103 suppresses infiltration of moisture and oxygen into the organic EL element 102. While not shown in the drawings, terminal portions for supplying electric power to the first electrode 102a and the second electrode 102c are led out from the encapsulating member 103.

The shape of the encapsulating member 103 is not particularly limited insofar as the encapsulating member 103 can protect the organic EL element 102 from the ambient air and can insulate the terminal portions led out to the outer periphery of the organic EL element 102. The encapsulating member 103 is made of, e.g., an inorganic material such as silicon nitride or the like, or an organic material such as a ultraviolet-cured resin or the like. Alternatively, the encapsulating member 103 may be formed of a glass substrate and a resin material for bonding the glass substrate and the transparent substrate 101 together.

The FPC 104 is a printed substrate provided with wiring lines for supplying electric power to the terminal portions led out to the outside of the encapsulating member 103. The wiring lines provided in the FPC 104 are used to electrically interconnect the connector 105 provided on the FPC 104 and the terminal portions electrically connected to the first electrode 102a and the second electrode 102c.

The terminal portions of the FPC 104 can be electrically connected by, e.g., an anisotropic conductive film (ACF) or an anisotropic conductive paste (ACP).

Examples of the FPC 104 include a single-side FPC, a double-side FPC, a multi-layer FPC and an F/R, either of which is composed of a base and a cover lay made of an insulating material, a metal foil and an adhesive agent. Polyimide, polyethyleneterephthalate, LCP (Liquid Crystal Polymer) or the like is used as the material of the base and the cover lay of the FPC 104. A copper foil is used as the metal foil. An epoxy-based adhesive agent or the like is used as the adhesive agent.

The connector 105 is a connector that receives the electric power for energizing the organic EL element 102. For example, a lead wire connected to an external power supply circuit is connected to the connector 105. DC power is inputted from the power supply circuit to the connector 105. The DC power thus inputted is supplied through the wiring lines and the terminal portions of the FPC 104. This makes it possible to generate a predetermined voltage between the first electrode 102a and the second electrode 102c, thereby causing the light emitting layer to emit light.

The connector 105 includes, e.g., a resin-made container and metal pins. The metal pins are connected to the wiring lines of the FPC 104.

(Holder)

Next, the holder 110 will be described with reference to FIGS. 7A to 8. FIG. 8 is a sectional view showing a protrusion portion of the holder 110 according to the present embodiment. FIG. 8 shows the cross section taken along line VIII-VIII in FIG. 7B.

The holder 110 is configured to hold the planar light emitter 100. The holder 110 engages with the fixture 30 such that the light emission surface of the planar light emitter 100 overlaps with the light-transmitting region 21.

The holder 110 is, e.g., a plate-shaped member, and is provided on the opposite surface of the planar light emitter 100 from the light emission surface. More specifically, as shown in FIG. 7A, the holder 110 is bonded to the encapsulating member 103 by a bonding member 111.

The holder 110 is made of, e.g., a material higher in strength than the planar light emitter 100. More specifically, the holder 110 is made of a material higher in strength than the material (e.g., glass) of the transparent substrate 101.

The holder 110 may be made of a material higher in heat conductivity. If the holder 110 is made of a material higher in heat conductivity, it is possible to make uniform the heat generated from the organic EL element 102, thereby improving the in-plane uniformity of the light emission. For example, the holder 110 is a metal plate such as an aluminum plate or the like.

When seen in a plan view, the holder 110 protrudes in the insertion direction of the light emitting module 40 beyond the contour of the planar light emitter 100. The contour of the planar light emitter 100 is, e.g., the contour of the transparent substrate 101. For example, as shown in FIG. 8, the end surface of the holder 110 protrudes outward by the length L beyond the end surface of the planar light emitter 100, i.e., the end surface of the transparent substrate 101.

In FIG. 7B, the insertion direction of the light emitting module 40 is the downward direction on the drawing sheet. As shown in FIG. 7B, the holder 110 protrudes in the insertion direction (downward on the drawing sheet) beyond the contour of the transparent substrate 101 (indicated by a thick broken line in FIG. 7B).

For example, as shown in FIG. 7B, the holder 110 has an area larger than the contour of the planar light emitter 100 when seen in a plan view. More specifically, the holder 110 has an area larger than the contour of the transparent substrate 101 when seen in a plan view and covers the entire surface of the transparent substrate 101.

As shown in FIG. 7A, the holder 110 protrudes outward beyond the end surface of the transparent substrate 101 even in the direction orthogonal to the insertion direction (in the left-right direction on the drawing sheet). Thus, the holder 110 can also hold the end surfaces of the planar light emitter 100 parallel to the insertion direction.

If the light emitting module 40 is deviated from the right direction and position when slidingly inserted into the fixture 30, the light emitting module 40 collides with the periphery of the insertion opening 31 of the fixture 30. Since the holder 110 protrudes beyond the contour of the planar light emitter 100 in the insertion direction, the end surface of the holder 110 rather than the planar light emitter 100 collides with the fixture 30.

It is therefore possible to prevent the end surface of the planar light emitter 100 from colliding with the fixture 30. For example, the transparent substrate 101 is a glass substrate which is not high in strength. Therefore, the possibility of breakage of the planar light emitter 100 can be reduced by preventing the collision of the planar light emitter 100 with the fixture 30.

The bonding member 111 is, e.g., a sticky silicon sheet, but is not limited thereto. The bonding member 111 may be any material capable of bonding and fixing the holder 110 and the encapsulating member 103 together.

The holder 110 may be made of a material lower in strength than the transparent substrate 101. For example, the holder 110 may be made of a shock-absorbing material. In the present embodiment, the fixture 30 presses the holder 110, thereby increasing the adhesion between the light emission surface and the light-transmitting member 20. For that reason, it is preferred that the pressed portion is made of a material high in strength.

As shown in FIGS. 7A and 7B, the holder 110 includes a hole 112.

The hole 112 engages with the salient portion 33 of the fixture 30. As shown in FIG. 7B, the hole 112 has a rectangular shape when seen in a plan view but is not limited thereto. The hole 112 may have any shape capable of allowing insertion of the salient portion 33 into the hole 112, e.g., a shape capable of engaging with the salient portion 33.

For example, the width of the hole 112 is substantially equal to the width of the salient portion 33. By inserting the salient portion 33 into the hole 112, it is possible to perform the positioning of the holder 110 with respect to the fixture 30. At this time, if the width of the hole 112 and the width of the salient portion 33 in the direction orthogonal to the insertion direction are set equal to each other, it is possible to perform the positioning of the holder 110 in the direction orthogonal to the insertion direction (in the left-right direction in FIG. 7B).

Thus, for example, even if a playing margin for the light emitting module 40 exists within the fixture 30, it is possible to insert the light emitting module 40 at a suitable position. In other words, the light emission surface can be properly superimposed on the light-transmitting region 21. The playing margin for the light emitting module 40 means the distance by which the light emitting module 40 can move within the fixture 30. For example, the playing margin for the light emitting module 40 is the difference between the distance between the two bonding portions 35 defining the transverse width of the fixture 30 and the width of the light emitting module 40.

In the present embodiment, the hole 112 is formed at the center of the holder 110. However, the present invention is not limited thereto. For example, the hole 112 is provided in the same number as the number of the salient portion 33. While there is illustrated an example in which the hole 112 penetrates through the holder 110, the hole 112 may not penetrate through the holder 110.

(Frame, Wooden Frame and Cover)

Subsequently, the frame 50, the wooden frame 60 and the rear surface cover 70 according to the present embodiment will be described with reference to FIG. 3.

The frame 50 holds and reinforces the light-transmitting member 20. For example, the frame 50 has a shape conforming to the periphery of the light-transmitting member 20. More specifically, the frame 50 is a hexagonal frame-shaped member and is provided with one or more crosspieces 51 arranged therein.

As shown in FIG. 3, the frame 50 includes three crosspieces 51. Two of the crosspieces 51 are parallel to each other and are orthogonal to the remaining one crosspiece 51. The crosspieces 51 are provided to reinforce the frame 50.

The frame 50 and the crosspieces 51 are made of, e.g., a metallic material such as stainless steel or the like. The number and arrangement of the crosspieces 51 are nothing more than one example and are not limited to the illustrated ones. A power supply for supplying electric power to the light emitting module 40 may be attached to the crosspieces 51.

The wooden frame 60 is provided at the peripheral edge of the light-transmitting member 20 to protect the edge portion of the light-transmitting member 20. The light-transmitting member 20, the frame 50 and the rear surface cover 70 are attacked to the wooden frame 60 in that order from the rear surface side. For example, the light-transmitting member 20 is fixed to the wooden frame 60 by fitting the light-transmitting member 20 to the wooden frame 60 and then screw-fixing the frame 50 to the wooden frame 60. Moreover, the rear surface cover 70 is screw-fixed to the frame 50 or the wooden frame 60.

The rear surface cover 70 is a cover that protects the rear surface of the light-transmitting member 20, i.e., the surface of the light-transmitting member 20 on which the fixture 30 and the light emitting module 40 are provided. The rear surface cover 70 is made of, e.g., a resin material such as plastic or the like, or a metallic material.

An attachment member to be attached to a specified attachment surface (e.g., a building part such as a wall or the like) may be provided in the rear surface cover 70.

(Salient Portion)

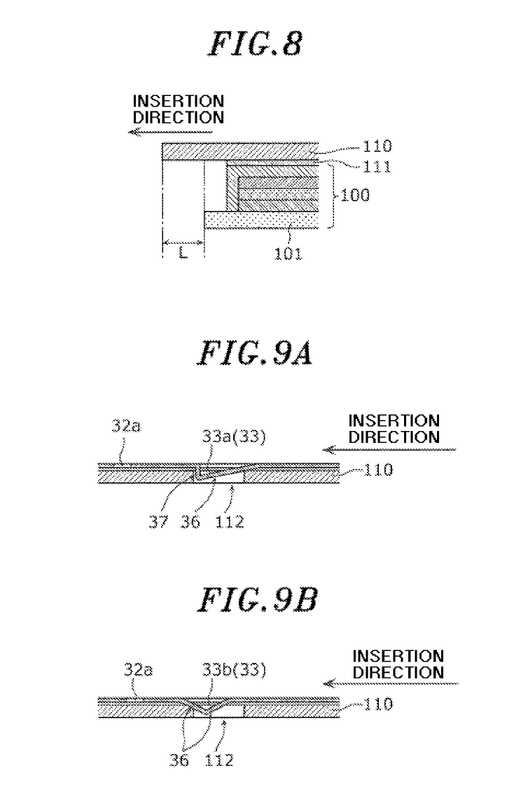

Subsequently, the details of the salient portion 33 of the fixture 30 will be described with reference to FIGS. 4, 9A and 9B. FIGS. 9A and 9B are sectional views showing one examples of the salient portion 33 of the fixture 30 according to the present embodiment. More specifically, FIGS. 9A and 9B show a cross section corresponding to a cross section taken along line IXA-IXA in FIG. 7B. In FIGS. 9A and 9B, for the sake of easy understanding, the holder 110 and the fixture 30 are shown but the planar light emitter 100 is not shown.

As shown in FIG. 9A, the salient portion 33a, which is one example of the salient portion 33, includes a slant surface 36 and a vertical surface 37. The salient portion 33a has a shape obtained by bending a portion of the flat plate portion 32. For example, as shown in FIG. 4, the salient portion 33a is formed by bending the portion surrounded by the cutout 32a.

The slant surface 36 is a surface slanted with respect to the insertion direction of the light emitting module 40. For example, the slant surface 36 is slanted toward the light-transmitting member 20 at a predetermined angle with respect to the insertion direction, i.e., the plane parallel to the flat plate portion 32. The predetermined angle is, e.g., about 1 to 10 degrees, but is not limited thereto.

The vertical surface 37 is a surface perpendicular to the insertion direction. For example, the vertical surface 37 is a surface extending vertically from the flat plate portion 32 and extending continuously from the slant surface 36. As shown in FIG. 9A, the salient portion 33a having a triangular cross section is formed by the vertical surface 37 and the slant surface 36.

The slant surface 36 and the vertical surface 37 may be separated from each other. That is to say, the cutout 32a may be provided between the slant surface 36 and the vertical surface 37.

When the light emitting module 40 is slidingly inserted into the fixture 30, the slant surface 36 is pressed by the end surface of the light emitting module 40, whereby the salient portion 33a is elastically deformed and lifted upward. The lifted salient portion 33a is slid along the holder 110 and is inserted into the hole 112. This makes it possible to smoothly insert the light emitting module 40.

Since the vertical surface 37 is locked to the wall surface of the hole 112, it is possible to prevent the light emitting module 40 from slidingly coming out from the insertion opening 31. That is to say, it is possible to prevent removal of the light emitting module 40.

The slant surface 36 presses the holder 110 with a reaction force generated by the elastic deformation. More specifically, the slant surface 36 presses a portion of the wall surface of the hole 112. This makes it possible to press the light emitting module 40 against the light-transmitting member 20.

In the present embodiment, the hole 112 is formed at the center of the holder 110. Thus, the slant surface 36 of the salient portion 33a can press the central portion of the holder 110. This makes it possible to uniformly apply a force to the light emitting module 40, thereby increasing the adhesion between the light emitting module 40 and the light-transmitting member 20.

As shown in FIG. 9B, the salient portion 33 according to the present embodiment may be a salient portion 33b including two slant surfaces 36. Unlike the salient portion 33a, the salient portion 33b includes the slant surface 36 in place of the vertical surface 37.

This makes it possible not only to slidingly insert the light emitting module 40 in a smooth manner but also to slidingly remove the light emitting module 40 in a smooth manner.

### SUMMARY

As described above, the illumination device 1 according to the present embodiment includes: the plate-shaped light-transmitting member 20 having the light-transmitting region 21; the fixture 30 having a box shape with one open surface, the fixture 30 attached to the light-transmitting member 20 such that the open surface faces the light-transmitting member 20; and the light emitting module 40 inserted into the fixture 30, wherein the fixture 30 includes the insertion opening 31 formed on a surface perpendicular to the open surface, the light emitting module 40 slidingly inserted into the insertion opening 31 along the light-transmitting member 20, the light emitting module 40 includes the planar light emitter 100 having a light emission surface and the holder 110 configured to hold the planar light emitter 100 and configured to engage with the fixture 30 such that the light emission surface overlaps with the light-transmitting region 21, and the holder 110 protrudes in an insertion direction of the light emitting module 40 beyond a contour of the planar light emitter 100.

Since the holder 110 protrudes in the insertion direction beyond the contour of the planar light emitter 100, it is possible to prevent the end surface of the planar light emitter 100 from colliding with the fixture 30 when the light emitting module 40 is slidingly inserted. As described above, according to the present embodiment, it is possible to provide the illumination device 1 provided with the adequately-protected planar light emitter 100.

The holder 110 is provided on the opposite surface of the planar light emitter 100 from the light emission surface and is larger in area than the contour of the planar light emitter 100.

Since the holder 110 is larger in area than the planar light emitter 100, it is possible for the holder 110 to cover and hide the planar light emitter 100 and to protect the planar light emitter 100 as a whole.

The fixture 30 includes a plate-shaped flat plate portion 32 which constitutes the opposite surface of the fixture 30 from the open surface and an elastically-deformable salient portion 33 protruding from the flat plate portion 32 toward the open surface.

By providing the elastically-deformable salient portion 33, it is possible to increase the pressure by which the light emitting module 40 is pressed against the light-transmitting member 20. This makes it possible increase the adhesion between the light emitting module 40 and the light-transmitting member 20.

The holder 110 includes the hole 112 configured to engage with the salient portion 33.

By causing the hole 112 and the salient portion 33 to engage with each other, it is possible to easily perform the positioning of the light emitting module 40.

The flat plate portion 32 includes the cutout 32a formed in a portion of a periphery of the salient portion 33, the salient portion 33 having a shape obtained by bending a portion of the flat plate portion 32.

This makes it possible to easily manufacture the fixture 30 by, e.g., a press work of a stainless steel plate.

The salient portion 33 includes the slant surface 36 slanted with respect to the insertion direction of the light emitting module 40.

Thus, when the light emitting module 40 is slidingly inserted, the slant surface 36 is pressed and naturally moved upward. This makes it possible to easily insert the light emitting module 40.

The salient portion 33 further includes a vertical surface 37 perpendicular to the insertion direction of the light emitting module 40.

Thus, the vertical surface 37 and the wall surface of the hole 112 of the holder 110 make contact with each other. This makes it possible to prevent the light emitting module 40 from being removed out of the insertion opening 31.

The light-transmitting member 20 further includes a mirror region 22 provided around the light-transmitting region 21 and configured to reflect external light.

Thus, when turned off, the illumination device 1 can be used as a mirror. When turned on, the illumination device 1 can be used as a partially shining mirror.

The planar light emitter 100 includes the second electrode 102c which reflects light, and the light-transmitting region 21 is configured to transmit external light when the light emitting module 40 is turned off and to transmit the external light reflected by the second electrode 102c.

Thus, the light-transmitting region 21 can be used as a mirror when the light emitting module 40 is turned off. This makes it possible to use, e.g., the entire surface of the light-transmitting member 20 as a mirror.

The flat plate portion 32 has a major surface facing the light-transmitting member 20, the major surface being a mirror surface.

Thus, if the light emitting module 40 is removed, the external light transmitted through the light-transmitting region 21 is reflected by the rear surface of the fixture 30. Accordingly, the illumination device 1 can be used as a mirror even when the light emitting module 40 is removed.

The fixture 30 is attached to the light-transmitting member 20 at a position closer to the edge of the light-transmitting member 20 than the center of the light-transmitting member 20 and the insertion opening 31 is provided at a position closer to the center of the light-transmitting member 20 than the edge of the light-transmitting member 20.

Thus, the fixture 30 and the light-transmitting region 21 are disposed at the positions closer to the edge of the light-transmitting member 20. This makes it possible to use the center of the light-transmitting region 21 as a mirror surface.

### Modified Examples

Modified examples of the illumination device 1 according to the present embodiment will now be described with reference to the drawings.

For example, in the illumination device 1 according to the present embodiment, the width of the insertion opening 31 of the fixture 30 is substantially equal to the width of the light emitting module 40. However, the present invention is not limited thereto. The width of the insertion opening 31 may be sufficiently larger than the width of the light emitting module 40.

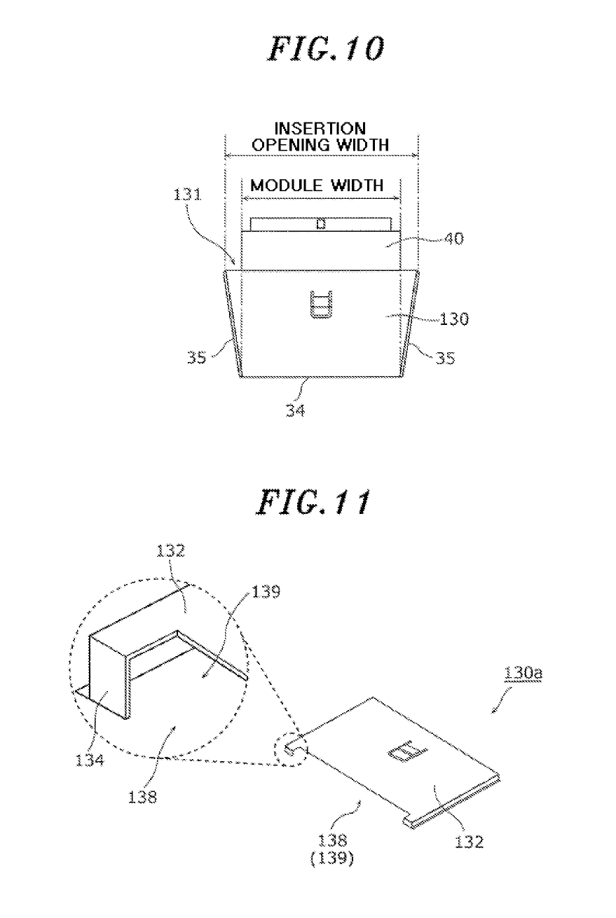

FIG. 10 is a plan view showing a fixture 130 according to a modified example of the present embodiment. As shown in FIG. 10, the insertion opening 131 of the fixture 130 is sufficiently larger in width than the light emitting module 40. In other words, the insertion opening 131 is larger in width than the contact portion 34.

More specifically, as shown in FIG. 10, two bonding portions 35 are provided so as to go away from each other as they extend from the contact portion 34 toward the insertion opening 131. While there is illustrated an example where the bonding portions 35 have a linear shape, the bonding portions 35 may be widened step by step or may be widened in a trumpet shape.

Since the width of the insertion opening 131 is larger than the width of the contour of the light emitting module 40, it is possible to easily insert the light emitting module 40 into the fixture 130. Furthermore, it is possible to reduce the possibility that the light emitting module 40 collides with the portion of the insertion opening 131 of the fixture 130. This makes it possible to adequately protect the planar light emitter 100.

In the illumination device 1 according to the present embodiment, when removing the light emitting module 40, the portion of the light emitting module 40 protruding outward from the fixture 30 is pressed and slid. However, the present invention is not limited thereto. An opening for use in pushing the light emitting module 40 outward may be provided in the fixture 30.

FIG. 11 is a perspective view showing a fixture 130a according to another modified example of the present embodiment. As shown in FIG. 11, the contact portion 134 of the fixture 130a has a first opening 138. The flat plate portion 132 of the fixture 130a has a second opening 139 joined to the first opening 138.

Thus, the light emitting module 40 can be pushed outward by, e.g., a finger, through the first opening 138 and the second opening 139. Accordingly, as compared with a case where the light emitting module 40 is pressed against the light-transmitting member 20, no force is applied to the light emission surface of the light emitting module 40. It is therefore possible to protect the light emission surface.

In the illumination device 1 according to the present embodiment, the holder 110 is provided so as to cover the entire surface of the planar light emitter 100. However, the present invention is not limited thereto. The holder 110 may protrude in the insertion direction of the light emitting module 40 so as to protect only the end portion of the planar light emitter 100.

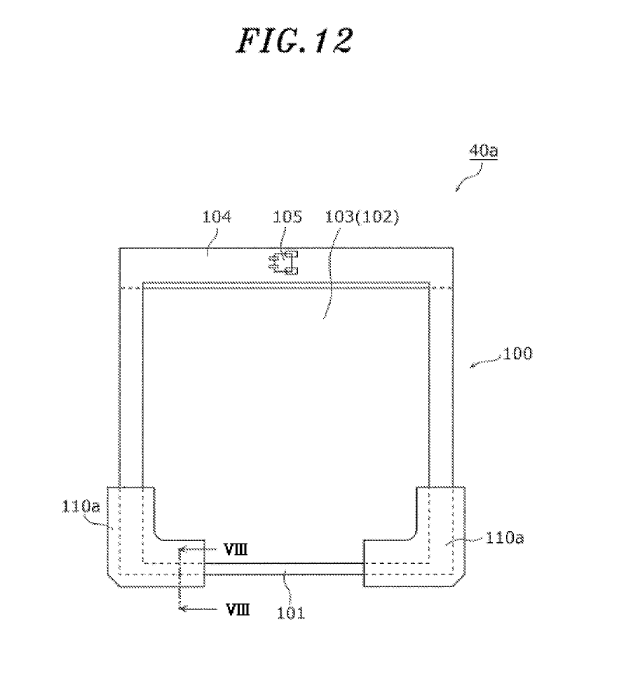

FIG. 12 is a plan view showing a light emitting module 40a according to a further modified example of the present embodiment. As shown in FIG. 12, holders 110a of the light emitting module 40a are provided so as to protect the end portion of the planar light emitter 100.

More specifically, the planar light emitter 100 according to the present embodiment has a rectangular shape. Two L-like holders 110a are attached to the planar light emitter 100 so as to cover two end portions positioned in the insertion direction. In this case, the cross section taken along line VIII-VIII in FIG. 12 is the same as the cross section shown in FIG. 8. It is therefore possible to adequately protect the planar light emitter 100 during the sliding insertion.

When the rectangular light emitting module 40a is slidingly inserted, the end portions of the light emitting module 40a corresponding to the corners of a rectangle are most likely to collide with the fixture 30 and are easily broken at the occurrence of collision. By protecting the corners of a rectangle with the holders 110a shown in FIG. 12, it is possible to adequately protect the light emitting module 40a.

(Others)

While the illumination device according to the present invention has been described above based on the embodiment and the modified examples thereof, the present invention is not limited to the aforementioned embodiment.

For example, in the aforementioned embodiment and the modified examples thereof, there is illustrated an example in which the light-transmitting regions 21 are simple diagrams such as a rectangle, a star and the like. However, the light-transmitting regions 21 may be formed into a complex shape.

When the illumination device 1 according to the present embodiment is turned off, not only the mirror region 22 but also the light-transmitting regions 21 can be used as a mirror. However, as described above, the light reflected by the light-transmitting regions 21 is the light transmitted through not only the light-transmitting regions 21 but also the first electrode 102a and the organic layer 102b of the planar light emitter 100. That is to say, the light reflected by the light-transmitting regions 21 differs from the light reflected by the mirror region 22. For that reason, if the light-transmitting regions 21 are simple diagrams, there is a fear that a user (the subject 10) may feel uncomfortable.

In contrast, if the light-transmitting regions 21 are formed into a complex shape, it is possible to use the light-transmitting regions 21 as mirrors that do not give an uncomfortable feeling particularly when the illumination device 1 is turned off. In other words, when the illumination device 1 is turned off, a user (the subject 10) can recognize the illumination device 1 as a mirror having a pattern in the peripheral portion thereof.

In the aforementioned embodiment and the modified examples thereof, there is illustrated an example in which the holder 110 is attached to the rear surface of the planar light emitter 100 (the encapsulating member 103). However, the present invention is not limited thereto. For example, the holder 110 may be provided on the insertion-direction end surface of the planar light emitter 100. Even in this case, it is possible to protect the end surface of the planar light emitter 100 when the light emitting module 40 is slidingly inserted into the fixture 30.

In the aforementioned embodi and the modified examples thereof, there is illustrated an example in which the fixture 30 includes the salient portion 33 one-piece formed therewith. However, the present invention is not limited thereto. The light emitting module 40 may be pressed against the light-transmitting member 20 by a member formed independently of the fixture 30. For example, a through-hole may be provided in the fixture 30 and the light emitting module 40 may be pressed against the light-transmitting member 20 by a screw or the like inserted into the through-hole.

In the aforementioned embodiment and the modified examples thereof, there is illustrated an example in which the illumination device 1 is a mirror capable of performing illumination. However, the present invention is not limited thereto. That is to say, the light-transmitting member 20 may not include the mirror region 22. For example, the region corresponding to the mirror region 22 may have a light transmitting property or a light shielding property. Similarly, the inner major surface of the fixture 30 may not be a mirror surface.

It is to be understood that the present invention encompasses the forms obtained by applying various kinds of modifications conceived by a person skilled in the art to the aforementioned embodiment and the forms realized by combining the component elements and functions of the aforementioned embodiment without departing from the spirit of the present invention.

What is claimed is:

1. An illumination device, comprising:
a plate-shaped light-transmitting member having a light-transmitting region;
a fixture having a box shape with one open surface, the fixture being attached to the light-transmitting member such that the open surface faces the light-transmitting member; and
a light emitting module inserted into the fixture,
wherein the fixture includes an insertion opening formed on a surface perpendicular to the open surface, the light emitting module slidingly being inserted into the insertion opening along the light-transmitting member,
wherein the light emitting module further includes a planar light emitter having a light emission surface and a holder configured to hold the planar light emitter and configured to engage with the fixture such that the light emission surface overlaps with the light-transmitting region, and
wherein the holder protrudes in an insertion direction of the light emitting module beyond a contour of the planar light emitter.

2. The illumination device of claim 1, wherein the holder is provided on the opposite surface of the planar light emitter from the light emission surface and is larger in area than the contour of the planar light emitter.

3. The illumination device of claim 1, wherein the fixture includes a flat plate portion which forms the opposite surface of the fixture from the open surface and an elastically-deformable salient portion protruding from the flat plate portion toward the open surface.

4. The illumination device of claim 3, wherein the holder includes a hole configured to engage with the salient portion.

5. The illumination device of claim 3, wherein the flat plate portion includes a cutout formed in a portion of a periphery of the salient portion, the salient portion having a shape obtained by bending a portion of the flat plate portion.

6. The illumination device of claim 3, wherein the salient portion includes a slant surface slanted with respect to the insertion direction of the light emitting module.

7. The illumination device of claim 6, wherein the salient portion further includes a vertical surface perpendicular to the insertion direction of the light emitting module.

8. The illumination device of claim 3, wherein the fixture includes a plate-shaped contact portion configured to forming a surface opposite to the insertion opening and configured to make contact with an end surface of the light emitting module, the insertion opening being larger in width than the contact portion.

9. The illumination device of claim 3, wherein the fixture includes a plate-shaped contact portion configured to form a surface opposite to the insertion opening and configured to make contact with an end surface of the light emitting module, the contact portion including a first opening.

10. The illumination device of claim 9, wherein the flat plate portion includes a second opening joined to the first opening.

11. The illumination device of claim 3, wherein the light-transmitting member further includes a mirror region provided around the light-transmitting region and configured to reflect external light.

12. The illumination device of claim 11, wherein the planar light emitter includes a reflection electrode which reflects light, the light-transmitting region configured to transmit external light when the light emitting module is turned off and to transmit the external light reflected by the reflection electrode.

13. The illumination device of claim 11, wherein the flat plate portion has a major surface facing the light-transmitting member, the major surface being a mirror surface.

14. The illumination device of claim 1, wherein the fixture is attached to the light-transmitting member at a position closer to an edge of the light-transmitting member than a center of the light-transmitting member and the insertion opening of the fixture is provided at a position closer to the center of the light-transmitting member than the edge of the light-transmitting member.
